(19) United States
(12) Patent Application Publication
(10) Pub. No.: US 2005/0244610 A1
(43) Pub. Date: Nov. 3, 2005

(54) Injection molding of components for vehicles

(75) Inventors: Donald J. Cvengros, Canton, MI (US); Mark Turner, Wixom, MI (US); Philip R. Spiess, Farmington Hills, MI (US); Brian D. Libs, Ann Arbor, MI (US)

Correspondence Address: VISTEON, C/O BRINKS HOFER GILSON & LIONE, PO BOX 10395, CHICAGO, IL, 60610, US

(73) Assignee: Visteon Global Technologies, Inc.

(21) Appl. No.: 10/835,154

(22) Filed: Apr. 29, 2004

(51) Int. Cl. B32B 3/10; B29C 45/14

(52) U.S. Cl. 428/137; 264/255; 264/279

(57) ABSTRACT

A process for making a plastic part for vehicles includes placing an insert into a mold and then injecting two resins into the mold on either side of the insert. The insert separates the two resins and adheres to the resins as the resins cool. The two resins may be the same color or different colors. The insert may be the same color as one of the other two resins, or the insert may be transparent or translucent.

### BACKGROUND

The present invention generally relates to injection molding. More specifically, the invention relates to injection molding of parts for vehicles.

Currently, when a plastic part is made of components having different colors, separate molds, one for each color, are used to produce each component. Various subsequent operations are then employed to connect the components together, for example, through the use of mechanical attachments, such as screws, heatstakes, clips, etc. This process, however, is labor-intensive and requires secondary operations to assemble the part and multiple molding tools. Further, the fit and finish of the final part has a poor appearance, resulting from the inconsistent gaps attributable to manufacturing variability of the parts and assembly processes.

Other processes involve masking a portion of the panel and then painting the panel to create a two-tone panel. Another process uses a mold with two cavities. Plastic parts for vehicles with panels or components with different colors have relied on the adhesion properties of the plastic resins to adhere the panels together during such molding processes. For example, for two-tone part, a resin having one color is injected into the mold and then cooled. The cavity subsequently rotates and a resin with a second color is injected into the mold. After the resins cool, a two-tone part is removed from the mold. While this process is less labor intensive than the process using mechanical attachments, the process time to use a mold with two cavities can be long, since the two components are cooled sequentially before the final part is removed from the mold. Moreover, this process requires a very complex dual cavity mold, with additional controls and mechanisms to handle the rotation of the mold during the processing cycle. Also, there is no separation between the two different resins to control the final surface appearance of the knit or flow lines between the resins.

### SUMMARY OF THE INVENTION

Generally, in one aspect, the present invention provides a method of making plastic parts for vehicles. The method includes placing an insert into a mold and injecting two resins into the mold on either side of the insert. The insert separates the two resins and adheres to the resins as the resins cool and form respective molded plastic components. The plastic components and the insert are then removed from the mold as an integrated plastic part. The insert can be formed from one of the two resins.

The two plastic components separated by the insert may be the same color or different colors. The insert may be the same color as one the two components. Alternatively, the insert may be transparent or translucent. The insert may include one or more interlocks to form a mechanical attachment with the plastic components as the resins cool.

In another aspect, a plastic part for a vehicle includes first and second components formed of respective first and second injected molded plastic material and an insert formed of a third injected molded plastic material. The first and second components adhere to the insert, and the insert separates the first and second components.

Embodiments of the invention may provide one or more of the following advantages. The plastic part may appear as an integrated continuous structure with two or more colors. Since a completed part is produced as one piece, painting and fastening systems may be eliminated. Multiple molding tools or multi-injection tools may also be eliminated.

Other features and advantages will be apparent from the following description and from the claims.

### BRIEF DESCRIPTION OF THE DRAWINGS

FIG. 1A is a perspective view of a plastic part for a vehicle made by conventional injection molding;

FIG. 1B is an exploded view of the plastic part of FIG. 1A;

FIG. 2 depicts components of a vehicle part made by an injection molding process in accordance with an embodiment of the invention;

FIG. 3 depicts the completed part of FIG. 2;

FIG. 4 is a cross sectional view of a mold with an insert for producing a two-tone plastic part in accordance with an embodiment of the invention;

FIG. 5 is a cross-sectional view of an alternative insert in accordance with the invention;

FIG. 6 is a cross-sectional view of yet another alternative insert in accordance with the invention;

FIGS. 7A and 7B depict yet another alternative insert in accordance with the invention;

FIG. 8 illustrates yet another alternative insert in accordance with the invention.

### DETAILED DESCRIPTION

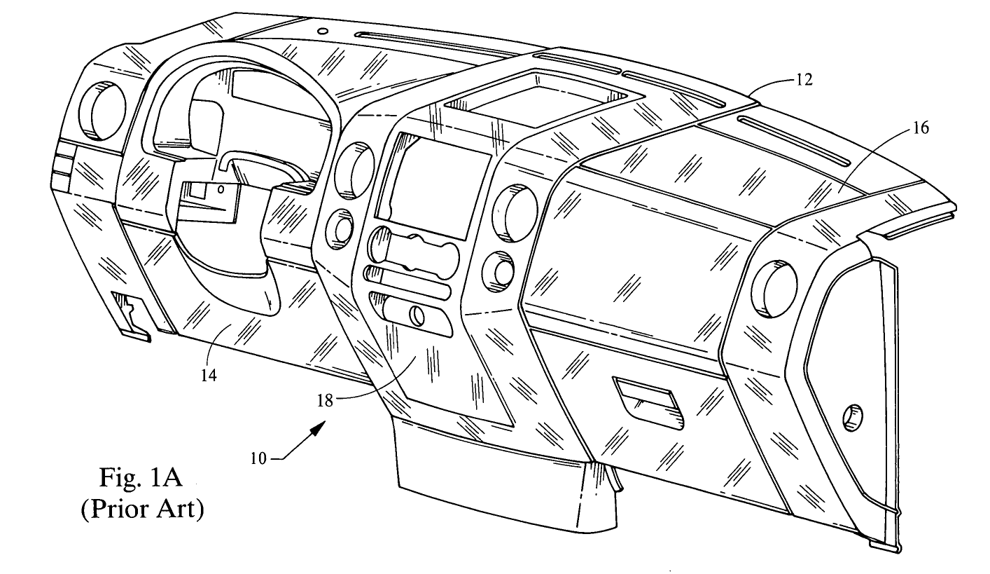

Referring to FIG. 1A, there is shown a perspective view of a multi-tone panel 10 produced by a conventional injection molding process. The panel 10 is illustrated in its “as intended” final shape. FIG. 1B illustrates the various components of the panel 10. Specifically, the panel 10 includes a primary panel 12, side panels 14 and 16, and a center panel 18. Each of the panels 12, 14, 16, and 18 are produced separately in a respective injection molding process, such that a different colored resin may be used for each component. The panels 12, 14, 16, and 18 are then assembled together as the final panel 10. The panels may be fastened together, for example, with mechanical attachments.

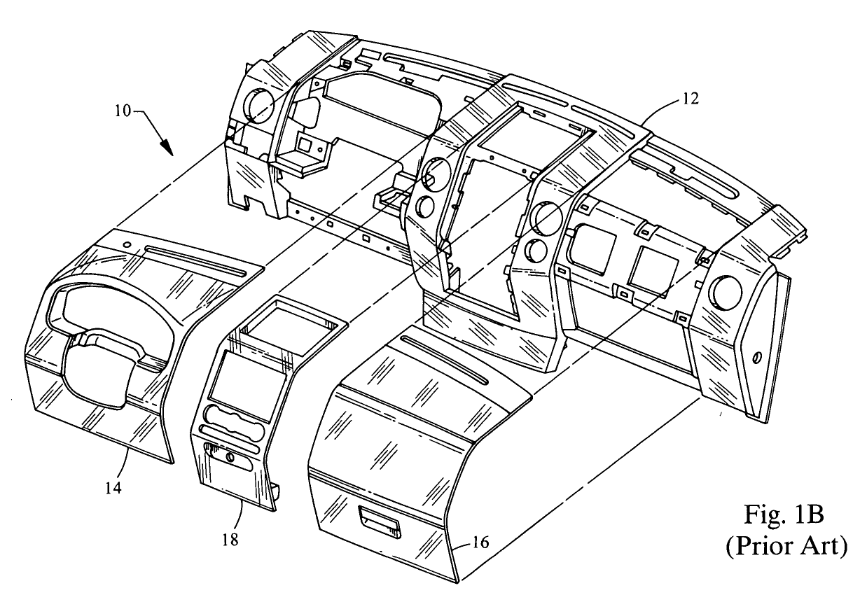

Referring now to FIG. 2, components of a two-tone panel embodying the principles of the present invention is illustrated therein and designated at 30. As its primary components, the panel 30 includes an upper panel 32, a lower panel 34, and an insert 36. The upper panel 32 and the lower panel 34 are made from different colored resins of plastic material. Although the insert 36 is shown as being produced from the same colored resin as that used for the lower panel 34, the colored resin used for the upper panel 32 can be used for the insert 36.

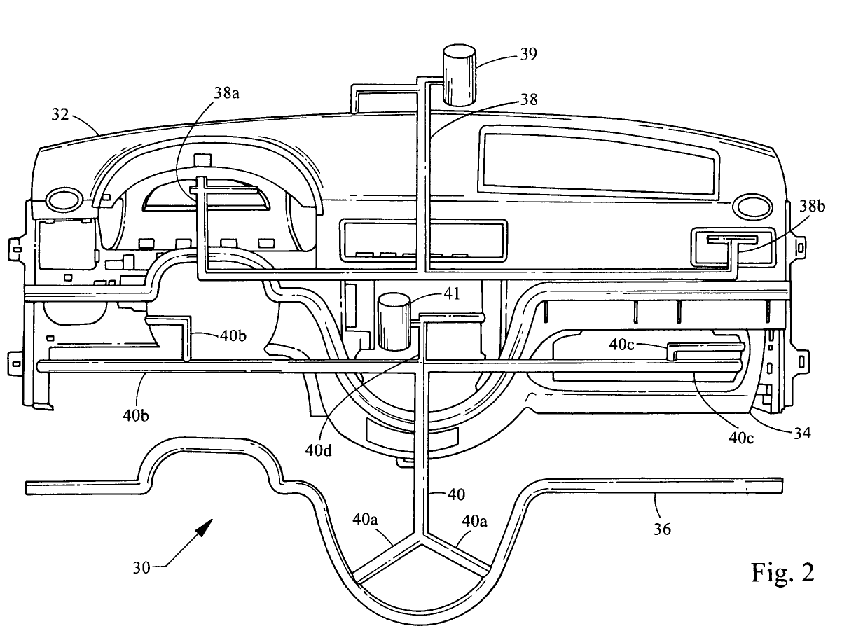

FIG. 3 illustrates the panel 30 in its final shape. The upper panel 32 is joined to the lower panel 34 with the insert 36. The insert 36 connects the upper panel 32 with the lower panel 34. To maintain the two-tone appearance of the panels 32 and 34, the insert is molded in one of the two colors of the panels 32, 34. As discussed in detail below, the insert 36 may be produced in the same tool used to mold the panels 32, 34, or the insert 36 may be produced in a separate mold.

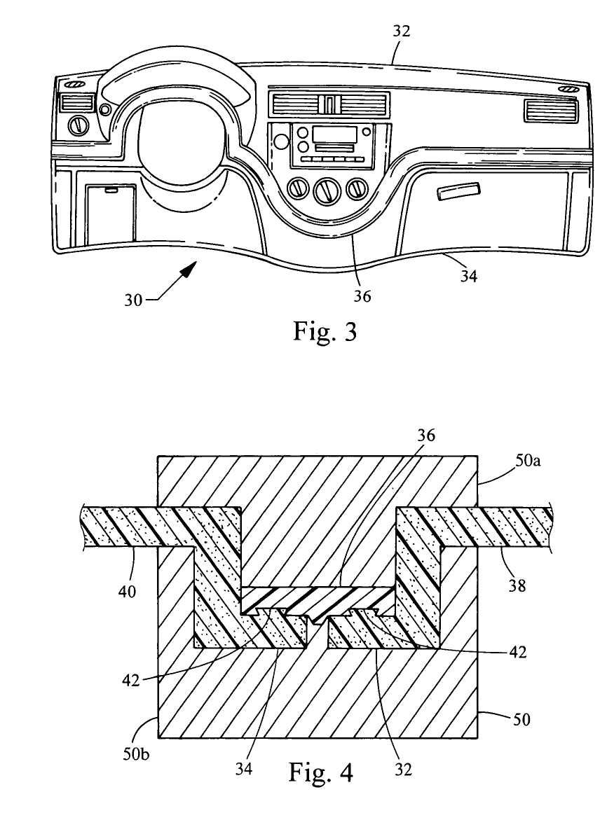

Referring to FIG. 4 in conjunction with FIG. 2, in one implementation, a resin reservoir 39 provides a colored resin for the upper panel 32, and another resin reservoir 41 provides a different colored resin for the lower panel 34 and the insert 36. A mold 50 includes an upper portion 50a and a lower portion 50b defining a primary cavity for the two-tone panels 32, 34. The mold 50 is also provided with a secondary cavity to mold the insert 36. Producing the insert 36 in the secondary cavity within the mold 50 with the same resin used to mold the lower panel 34 helps ensure a color match with the lower panel.

Initially, resin from the reservoir 41 flows through a manifold 40 and submanifolds 40a into the secondary cavity of the mold 50 to fill the secondary mold cavity. Subsequent cooling of the resin in the secondary cavity provides the insert 36 in its hardened form. Note that during the insert fabrication cycle, resin flowing into the primary cavity is scrap that is subsequently discarded. This insert 36 is then manually or robotically placed into the primary cavity and held in the place before the next cycle during which the two different color resins for the panels 32, 34 are injected on either side of the insert 36. The insert 36 can be held in the primary cavity with a mechanical interlock mechanism such as a slide/lifter. Additionally, or alternatively, a vacuum may be applied to the insert 36 to hold it in place.

To produce the upper and lower panels 32, 34, resin from the reservoir 39 flows through a manifold 38 and sub-manifolds 38a and 38b into the primary cavity of the mold 50 for the upper panel 32, while the different colored resin from the reservoir 41 flows though the sub-manifolds 40b, 40c, and 40d into the primary cavity on the other side of the insert 36 for the lower panel 34. As the resins for the panels 32, 34 fill the primary cavity of the mold 50, the insert 36 acts as a barrier between the two resins. When the resins contact the insert 36, the resins make an adhesive bond with the insert. To further help maintain stability of the bond between the two resins and further increase the connection between the insert and the panels 32, 34, sections throughout the insert include a mechanical lock 42 between the insert 36 and the two colored resins of the panels 32, 34. Upon completion of the cooling cycle for the resins, the panel 30 is removed as a single integrated piece as previously shown in FIG. 3. Thus, the use of the insert 36 provides a robust and durable knit line and adhesion between the two different panels 32, 34.

Although a secondary cavity in the mold 50 may be used to produce the insert 36, such a secondary cavity is not required. That is, the insert 36 could be made in a separate mold. If made separately, the interlocking insert is then placed within the primary cavity prior to injecting the two resins for the panels 32, 34.

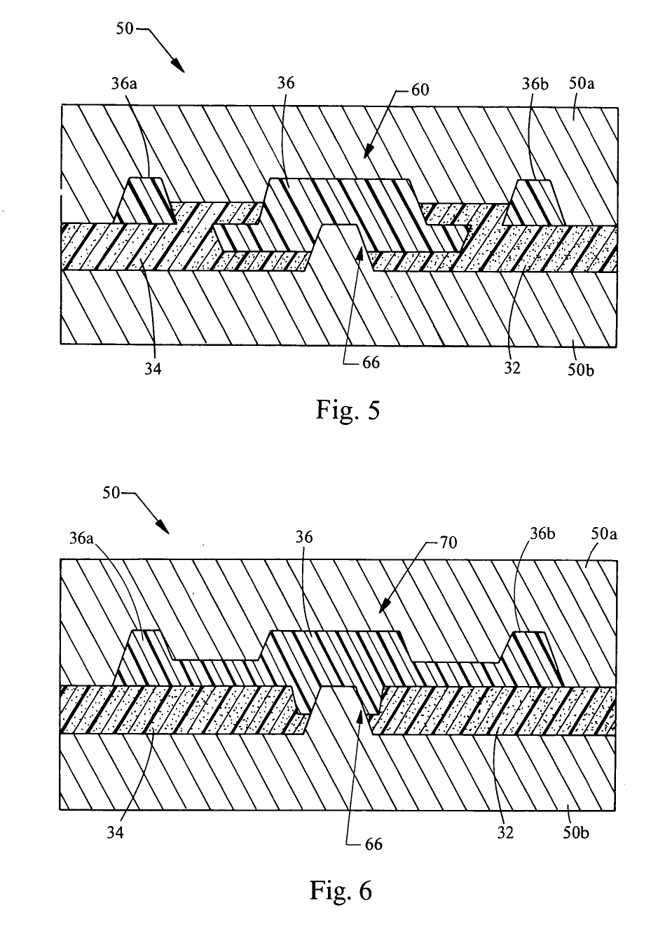

As mentioned above, in addition to the adhesive bond between the insert 36 and the upper and lower panels 32, 34, the interlocks 42 strengthen the connection between the insert 36 and the panels 32, 34. Note that implementations other than that shown in FIG. 4 can be employed to join the panels 32, 34 together. For example, an alternative implementation designated as 60 in FIG. 5 uses the insert 36 with two interlocks 36a, 36b to form the mechanical connection between the insert 36 and the two panels 32, 34. Note that the interlocks 36a, 36b also act as ribs to provide structural rigidity to the connection between the panels 32, 34.

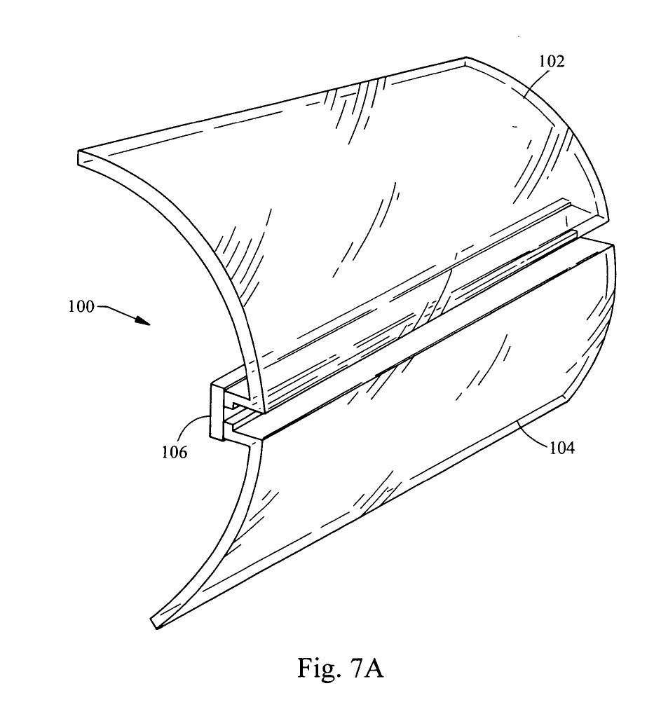

Referring to FIG. 6, in another implementation designated as 70, the connection between the panels 32, 34 is formed through an adhesive bond with the insert 36. In this implementation, the insert 36 is also provided with ribs 36a, 36b to provide additional structural support for the connection between the panels 32, 34.

Note that the insert 36 in any of the above implementations can be molded with a design groove (or without a groove if desired). A groove, for example, as designated at 66 in FIGS. 5 and 6, in the insert 36 can be employed to improve the final surface appearance of the panel 30 by hiding the molded knit lines within the groove 66. That is, the groove 66, helps maintain a constant knit line between the panels 32, 34 and the insert 36. The groove 66 can also function as a design feature to separate the surface grain of the upper and lower panels.

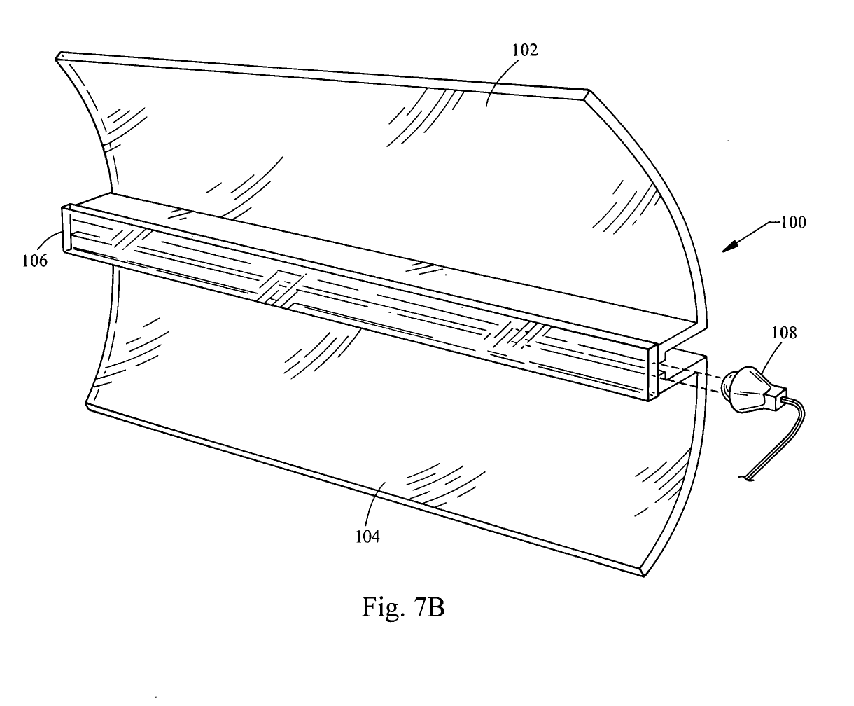

Implementations of the invention can be used to produce a part with a pair of panels that are illuminated along the juncture between the panels. For example, as shown in FIGS. 7A and 7B, a panel 100 includes an upper subpanel 102 and a lower subpanel 104 joined together with a transparent or translucent insert 106. The panel 100 is produced in accordance with the principles described above. That is, the insert 106 is first molded in a secondary cavity of a mold and then placed in a primary cavity of the mold, or the insert may be molded in a different molding tool. After the inert 106 cools and hardens, the insert 106 is placed into the primary cavity and resin for the panels 102 and 104 are injected into the primary cavity of the mold on either side of the insert 106. As described earlier, the resins for the panels 102, 104 form an adhesive bond with the insert 106, such that upon cooling of the resin for the panels 102, 104, a single panel 100 is formed. The panels 102, 104 may be the same color or they may be different colors. The connection between the panels 102, 104 and the insert 106 may be further strengthened with any of the aforementioned interlocks. When the panel 100 is installed in the vehicle, a light source 108 may be employed as shown to illuminate the insert 106 along the length of the insert.

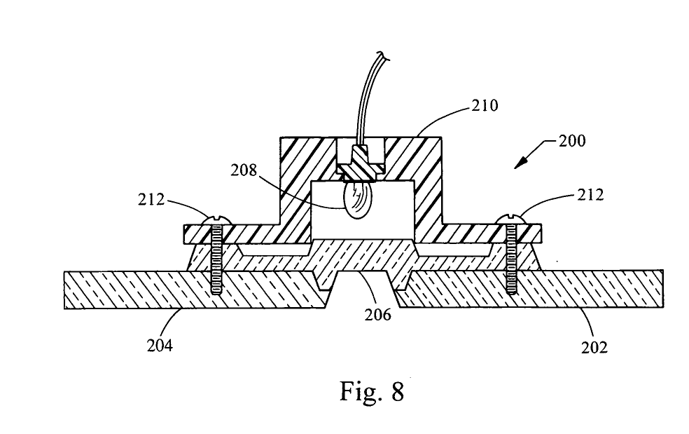

An alternative arrangement shown in FIG. 8 as a panel 200 includes a pair of panels 202, 204 and a translucent or transparent panel 206 attached to the panels 202 and 204. A light source such as a bulb 208 is mounted in a housing 210 that is attached to the panels 202, 204 with screws 212. Thus, the structural connection between the panels 202, 204 is provided through adhesion with the insert 206 and the mechanical attachment to the housing 210. The panels 202, 204 and the insert 206 may be molded as described above. That is once molded, the insert 206 can be placed in a primary cavity of a mold, and the resins for the panels 202, 204 can then be injected into the mold such that an adhesive bond is formed between the insert 206 and the panels 202, 204. The insert 206 may be provided with additional interlocks to strengthen the connection between the insert 206 and the panels 202, 204. The panels may be the same color or they may be different colors.

The above and other implementations of the invention are within the scope of the following claims.

1. A method of making a plastic part comprising:
placing an insert into a mold
injecting a first resin into the mold;
injecting a second resin into the mold,
the first resin and the second resin adhering to the insert and being separated by the insert; and
cooling the first and second resins to harden the resins, the plastic part being formed of the hardened first and second resins and the insert.

2. The method of claim 1 wherein the colors of the first and second resins are different.

3. The method of claim 1 wherein the first and second resins have the same color.

4. The method of claim 1 wherein the insert is the same color as either the first or second resins.

5. The method of claim 1 wherein the insert is a different color than the colors of the first and second resins.

6. The method of claim 1 wherein the insert in translucent.

7. The method of claim 1 wherein the insert in transparent.

8. The method of claim 1 wherein the insert is molded in a second mold before being placed in the first mold.

9. The method of claim 1 wherein the insert is molded in a secondary cavity of the mold and the injecting includes injecting into a primary cavity of the mold.

10. The method of claim 1 wherein the insert is held in the mold mechanically.

11. The method of claim 1 wherein the insert is held in the mold by a vacuum.

12. The method of claim 1 wherein the insert has a groove.

13. The method of claim 1 wherein the insert if formed without a groove.

14. The method of claim 1 wherein the insert includes at least one interlock to mechanically connect the insert to the hardened resins.

15. A plastic part comprising:
a first component formed of a first injected molded plastic material;
a second component formed of second injected molded plastic material; and
an insert formed of a third injected molded plastic material, the first and second components adhering to the insert, the insert separating the first and second components.

16. The plastic part of claim 15 wherein the third injected molded plastic material has the same color as either the first injected molded plastic material or the second injected molded plastic material.

17. The plastic part of claim 15 wherein the third injected molded plastic material has a different color than the colors of the first injected molded plastic material and the second injected molded plastic material.

18. The plastic part of claim 15 wherein the first injected molded plastic material has a different color than the color of the second injected molded plastic material.

19. The plastic part of claim 15 wherein the first injected molded plastic material and the second injected molded plastic material are the same color.

20. The plastic part of claim 15 wherein the insert is transparent.

21. The plastic part of claim 15 wherein the insert is translucent.

22. The plastic part of claim 15 wherein the insert includes at least one interlock to mechanically connect the insert to the first and second injected molded plastic materials.
